(19) United States
(12) Patent Application Publication
(10) Pub. No.: US 2016/0328944 A1
(43) Pub. Date: Nov. 10, 2016

(54) NOTIFICATION SYSTEM

(71) Applicant: HOUNGFU TECHNOLOGY CO., LTD., Taipei (TW)

(72) Inventor: Chun-Jen Chen, Taichung (TW)

(21) Appl. No.: 14/857,829

(22) Filed: Sep. 18, 2015

(30) Foreign Application Priority Data
May 5, 2015 (TW) 104206858

(51) Int. Cl. G08B 21/18

(52) U.S. Cl. CPC G08B 21/18

(57) ABSTRACT

A notification system includes a switch device, an alarm device, a detection module, a central control module, a drive module, an encoder module and a communication module. The detection module coupled to the switch device is configured to detect a state of the switch device. The central control module coupled to the detection module is configured to receive the state of the switch device and accordingly generate a notification signal and a driving signal. The drive module coupled to the central control module is configured to receive the driving signal and accordingly drive the alarm device and the switch device. The encoder module coupled to the central control module is configured to receive the notification signal and encode the notification signal into an encoded notification signal according to a protocol. The communication module coupled to the central control module is configured to receive and transmit the encoded notification signal.

### FIELD OF THE INVENTION

The present invention relates to a notification system, and more particularly to a notification system capable of responding to various protocols.

### BACKGROUND OF THE INVENTION

Generally, various detection or alarming devices are disposed for quickly determining the incident location and informing the related people when an abnormal condition (such as someone is trying to break windows or doors to get in or out from a house) occurs. Therefore, it is an important object to design a notification system capable of alarming and informing the related people in tune when an abnormal condition occurs.

### SUMMARY OF THE INVENTION

Therefore, one object of the present invention is to provide a notification system capable of alarming and informing the related people in time when an abnormal condition occurs.

The present invention provides a notification system, which includes a switch device, an alarm device, a detection module, a central control module, a drive module, an encoder module and a communication module. The detection module, electrically coupled to the switch device, is configured to detect a state of the switch device. The central control module, electrically coupled to the detection module, is configured to receive the state of the switch device and accordingly generate a notification signal and a driving signal. The drive module, electrically coupled to the central control module, is configured to receive the driving signal and accordingly drive the alarm device and the switch device. The encoder module, electrically coupled to the central control module, is configured to receive the notification signal and encode the notification signal into an encoded notification signal according to a protocol. The communication module, electrically coupled to the central control module, is configured to receive and transmit the encoded notification signal.

In one embodiment, the notification system further includes a receiver device. The receiver device is configured to receive the encoded notification signal from the communication module through a network. The receiver device is selected from a group consisting of a smart phone, a network telephone and a desktop computer.

In summary, the present invention discloses a notification system able to activate an alarm device e.g., a sound-alarming device or a light-flashing device) and immediately open or close a switch device (e.g., a security lock) when detecting an abnormal condition. In addition, the notification system also outputs a. notification signal according to the abnormal condition, encodes the notification signal according to a specific protocol, and transmits the encoded notification signal to a corresponding receiver device (e.g., a smart phone, a network telephone or a desktop computer) through a network. Thus, when the receiver device receives the notification signal issued from the notification system, a particular man (e.g., a security guard, a fireman or a policeman) having the receiver device can quickly run to the position of the notification system having the alarming sound or flashing light for the subsequent processing, thereby facilitating the notification speed and usage convenience of the notification system of the present invention. In addition, because the notification system of the present invention is directly coupled to the receiver device through a network, no any additional relay host (e.g., a SIP host with SIP protocol) is required for passing the notification signal; therefore, the notification system of the present invention has lower cost and higher economic efficiency.

### BRIEF DESCRIPTION OF THE DRAWING

FIG. 1 is a schematic diagram of a notification system in accordance with an embodiment of the present invention; and

FIG. 2 is a schematic block diagram of a notification system in accordance with an embodiment of the present invention.

### DETAILED DESCRIPTION OF PREFERRED EMBODIMENTS

The present invention will now be described, more specifically with reference to the following embodiments. It is to be noted that the following descriptions of preferred embodiments of this invention are presented herein for purpose of illustration and description only. It is not intended to be exhaustive or to be limited to the precise form disclosed.

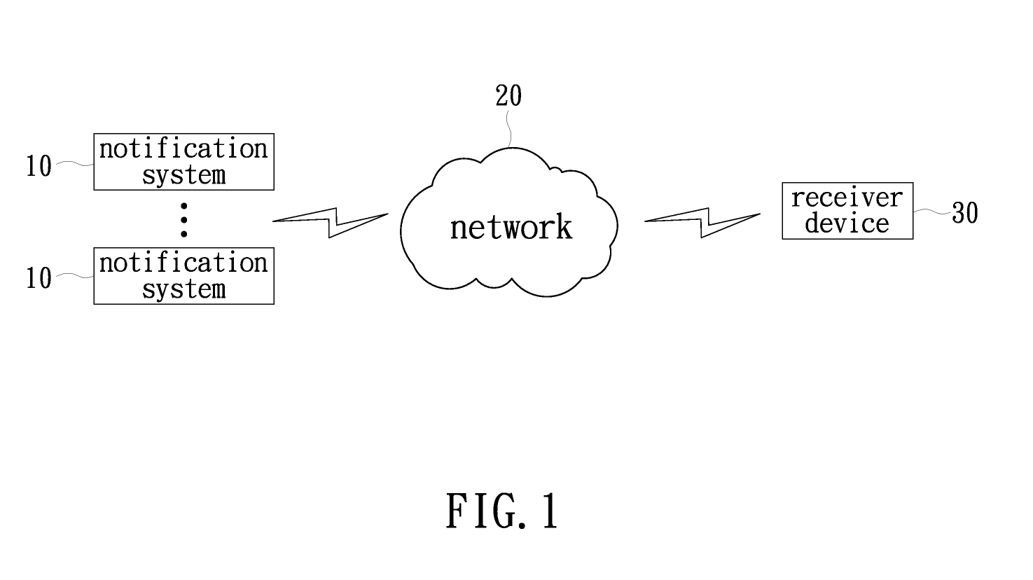

Referring to FIG. 1, which is a schematic diagram of a notification system in accordance with an embodiment of the present invention. Preferably, the notification system 10 of the present invention may be installed to doors or windows of some buildings, such as schools, commercial buildings, hospitals, homes and other particular spaces. As shown in FIG. 1, the one or more notification systems 10 in the present embodiment are coupled to a receiver device 30 through a network 20. In one embodiment, the receiver device 30 may be smart phone, network telephone, desktop computer and other similar devices. In one embodiment, the receiver device 30 is installed with programs or software corresponding to the notification system 10. Therefore, when an abnormal condition occurs, the notification system 10 transmits a notification signal, which includes an identification code and an abnormal condition occurrence time of the notification system 10, to the receiver device 30 through the network 20. In response to receive the notification signal, the receiver device 30 uses the installed programs or software to analyze the received notification signal, thereby obtaining the identification code and the aforementioned abnormal condition occurrence time of the notification system 10 having an abnormal condition.

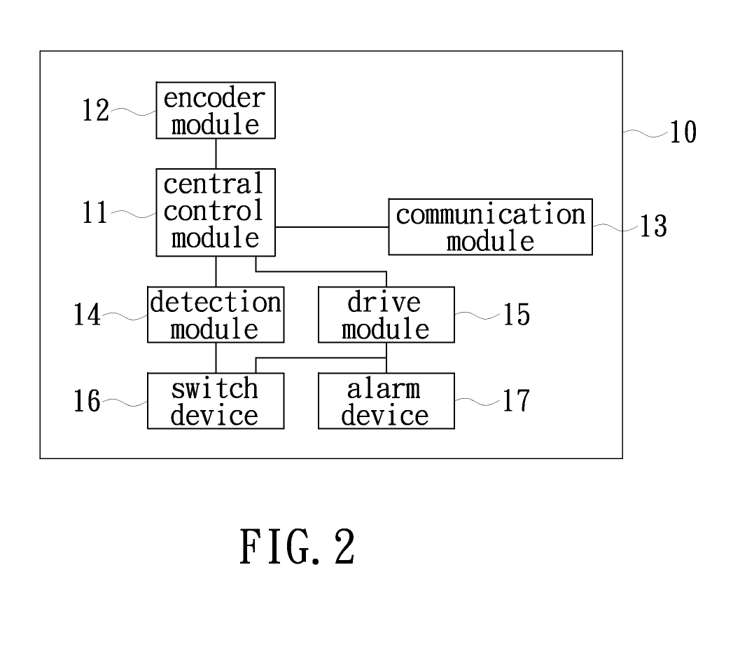

Referring to FIG. 2, which is a schematic block diagram of a notification system in accordance with an embodiment of the present invention. As shown in FIG. 2, the notification system 10 in the present embodiment includes a central control module 11, an encoder module 12, a communication module 13, a detection module 14, a drive module 15, a switch device 16, and an alarm device 17. In one embodiment, the switch device 16 may be security lock, anti-suicide lock or magnetic reed switch having switching function. In one embodiment, the alarm device 17 may be sound-alarming device or light-flashing device having alarming function. The detection module 14, electrically coupled to the switch device 16, is configured to detect the state (i.e., open or close) of the switch device 16 and transmit the state of the switch device 16 to the central control module 11. The central control module 11 is electrically coupled to the encoder module 12, the communication module 13, the detection module 14 and the drive module 15. In one embodiment, the central control module 11 may be a control device such as Advanced RISC Machine (ARM) processor, microcontroller or single chip microcomputer. The central control module 11 is configured to receive the state of the switch device 16 from the detection module 14 and determine whether the received state is in an abnormal state or not. Specifically, it is determined that the switch device 16 is in an abnormal condition when the state of the switch device 16 indicates that the switch device 16 (e.g., a security lock) is open, therefore the central control module 11 outputs the notification signal and a driving signal according to the received state of the switch device 16. As mentioned above, this notification signal includes the identification code of the respective notification system 10 and the abnormal condition occurrence time of the respective notification system 10 (specifically, the switch device 16 of the respective notification system 10) having the abnormal condition.

The drive module 15, electrically coupled to the central control module 11, is configured to receive the driving signal from the central control module 11 and drive the alarm device 17 and the switch device 16 according to the received driving signal. The encoder module 12 is configured to receive the notification signal from the central control module 11 and encode the content of the received notification signal into an encoded notification signal according to the protocol employed in the receiver device 30, such as the Transmission Control Protocol (TCP), User Datagram Protocol (UDP). Session Initiation Protocol (SIP) and other network protocols. Thus, the receiver device 30 can successfully receive and read the encoded notification signal having the compatible protocol. For an example that the receiver device 30 is an intern telephone, the encoder module 12 is configured to encode the content of the received notification signal according to SIP protocol, and therefore the notification signal is encoded into having a SIP packet format. Thus, the receiver device 30 can successfully receive and read the encoded notification signal transmitted in SIP packet format. It is understood that the communication module 13 may be a wireless communication module realized by a wireless network communications chip in one embodiment and may be a wired communication module realized by a wired network communications chip in another embodiment. After receiving the encoded notification signal, the communication module 13 is configured to edit the encoded notification signal into having a specific signal format capable of being transmitted through the network 20. Thus, when the encoded notification signal is transmitted to the receiver device 30 through the network 20, the receiver device 30 can obtain, through the installed program or software, the identification code and the abnormal condition occurrence time of the respective notification system 10 having an abnormal condition.

The embodiments of the present invention will be exemplarily illustrated by a particular situation as follow, but the present invention is not limited thereto. In this particular situation, the notification systems 10 are installed at a school. In response to receive the state of the switch device 16 from the detection module 14 and determine that the switch device 16 is in an abnormal condition (e.g., the switch device 16 (e.g., a security lock) is open), the central control module 11 generates the driving signal and transmits the driving signal to the drive module 15. The drive module 15 then accordingly actuates the alarm device 17 (e.g., a sound-alarming device or a light-flashing device) and closes the switch device 16 (e.g., a security lock) which is open. At the same time, the central control module 11 also generates the notification signal such as “A100; 20: 05,” which indicates the identification code (A100) and the abnormal condition occurrence time (20: 05) of the respective notification system 10. The central control module 11 also transmits the notification signal to the encoder module 12. The encoder module 12 then encodes the received content (such as “A100; 20: 05”) of the received notification signal based on the protocol (such as SIP) employed in the receiver device 30 and generates the encoded notification signal. The communication module 13 then transmits the encoded notification signal to the receiver device 30 (e.g., a network telephone hold by a school security) through the network 20. As a result, when any abnormal condition occurs, the central control module 11 can immediately actuate the alarm device 17 and therefore the school securities can run to the position of the notification system 10 having the alarming sound or flashing light. Meanwhile, through the content “A100; 20: 05” which is obtained through an analyzing of the installed program or software on the encoded notification signal and displayed on the receiver device 30 (e.g., a network telephone), the school securities can specifically identify the location of the respective notification system 10 with the identification code A100 and know that the respective notification system 10 detected an abnormal condition at time 20:05. Thus, the school securities can quickly reach to the particular location and eliminate the abnormal condition.

In summary, the present invention discloses a notification system able to activate an alarm device (e.g., a sound-alarming device or a light-flashing device) and immediately open or close a switch device (e.g., a security lock) when detecting an abnormal condition. In addition, the notification system also outputs a notification signal according to the abnormal condition, encodes the notification signal according to a specific protocol, and transmits the encoded notification signal to a corresponding receiver device (e.g., a smart phone, a network telephone or a desktop computer) through a network. Thus, when the receiver device receives the notification signal issued from the notification system, a particular man (e.g., a security guard, a fireman or a policeman) having the receiver device can quickly run to the position of the notification system having the alarming sound or flashing light for the subsequent processing, thereby facilitating the notification speed and usage convenience of the notification system of the present invention. In addition, because the notification system of the present invention is directly coupled to the receiver device through a network, no any additional relay host (e.g., a SIP host with SIP protocol) is required for passing the notification signal; therefore, the notification system of the present invention has lower cost and higher economic efficiency.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A notification system, comprising:
a switch device;
an alarm device;
a detection module, electrically coupled to the switch device, configured to detect a state of the switch device;
a central control module, electrically coupled to the detection module, configured to receive the state of the switch device and accordingly generate a notification signal and a driving signal;
a drive module, electrically coupled to the central control module, configured to receive the driving signal and accordingly drive the alarm device and the switch device;
an encoder module, electrically coupled to the central control module, configured to receive the notification signal and encode the notification signal into an encoded notification signal according to a protocol; and
a communication module, electrically coupled to the central control module, configured, to receive and transmit the encoded notification signal.

2. The notification system according to claim 1, further comprising a receiver device, configured to receive the encoded notification signal from the communication module through a network, wherein the receiver device is selected from a group consisting of a smart phone, a network telephone and a desktop computer.

3. The notification system according to claim 1, wherein the notification signal includes an identification code of the notification system.

4. The notification system according to claim 1, wherein the notification signal includes an abnormal condition occurrence time, which indicates a detected time of the switch device being open or close.

5. The notification system according to claim 1, wherein the central control module is selected from a group consisting of an Advanced RISC Machine (ARM) processor, a microcontroller and a single chip microcomputer.

6. The notification system according to claim 1, wherein the switch device is selected from a group consisting of a security lock, an anti-suicide lock and a magnetic reed switch.

7. The notification system according to claim 1, wherein the alarm device is selected from a group consisting of a sound-alarming device and a light-flashing device.

8. The notification system according to claim 1, wherein the protocol is selected from a group consisting of a Transmission Control Protocol (TCP), a User Datagram Protocol (UDP) and a Session initiation Protocol (SIP).

9. The notification system according to claim 1, wherein the communication module is selected from a group consisting of a wireless communication module and a wired communication module.

10. The notification system according to claim 9, wherein the communication module is selected from a group consisting of a wireless network communications chip and a wired network communications chip.
